(19) United States
(12) Patent Application Publication
(10) Pub. No.: US 2002/0175125 A1
(43) Pub. Date: Nov. 28, 2002

(54) Method for removing pollutants from a photographic effluent

(75) Inventor: Didier J. Martin, Givry (FR)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/044,078

(22) Filed: Jan. 10, 2002

(30) Foreign Application Priority Data
Jan. 30, 2001 (FR) 0101175

(51) Int. Cl. B01D 21/01; B01D 61/00

(52) U.S. Cl. 210/723; 210/724; 210/650

(57) ABSTRACT

The present invention relates to a method for removing pollutants from aqueous photographic effluent containing silver in completed form and (or) thiosulfates. This method comprises the steps of:

a) adding to said aqueous photographic effluent at least one agent able to combine with the silver and (or) the thiosulfate and to form at least one compound of molecular weight Mₓ, and to form two phases, liquid and solid,

b) adjusting the pH to a value between 3 and 6.5, and

c) allowing the effluent to pass through a nanofiltration unit with a cut-off threshold lower than Mₓ.

### FIELD OF THE INVENTION

The present invention relates to a method for removing from an aqueous photographic effluent silver in complexed form and thiosulfates contained therein, and more specifically a method for reducing the quantity of water and chemicals needed for photographic processing.

The invention further relates to a method for the photographic processing of a photographic material containing exposed silver halides, that consumes less water and less chemicals.

### BACKGROUND OF THE INVENTION

More specifically, the invention relates to a method for the treatment of a seasoned stabilization bath containing pollutants derived from the fixing or fixing-bleaching bath.

A number of manufacturing or processing methods produce effluents that cannot be discharged directly into the sewers because of their composition, but that contain substances the reclamation and re-use of which may be economically worthwhile. One example of this is the processing of photographic materials, in which exposed photographic films and papers pass through several processing baths containing high concentrations of chemicals. Such methods for the processing of photographic films are for example described in Chimie et Physique Photographiques, Pierre Glafkidès, Vol. 2, Chapt. XL, pages 947-967, 5^{ème} Ed, 1986), or in Modem Photographic Processing, O. Haist, vol 2, Chapt 7 & 10, J; Wiley & Sons, New York, 1978.

The processing of photographic materials comprises a developing step and a fixing step. In the fixing step, fixing agents are used, the function of which is to complex and dissolve silver halides remaining in the photographic material after the development step. In the case of color photographic materials, there is also bleaching step, which can be combined with a fixing step. The most usual fixing agent is a thiosulfate, possibly in association with various other substances.

Photographic materials are generally developed automatically and as rapidly as possible. During processing, the exposed photographic material passes through a succession of tanks each containing a bath performing the developing, fixing, bleaching or bleach-fixing steps described above. As the photographic material passes from one tank to the next, significant quantities of chemicals can be carried over either by the photographic material itself, or by the belts that convey the photographic material. These chemicals accumulate in the “seasoned” processing baths and reduce their efficacy. The faster the processing of photographic materials, the worse the contamination of baths by the carry-over of chemicals from a previous bath.

To overcome this reduction in the efficacy of a seasoned bath, it is common practice to add a replenishing solution to the bath and run off by overflow an equivalent volume of spent bath. This method generates a volume of spent baths that can no longer be used for photographic processing.

It is common practice to place washing baths between successive processing baths. In particular after passage through a fixing or fixing-bleaching bath the film passes through several washing baths to prevent too heavy contamination with chemicals such as thiosulfates, complexed silver, complexed iron or sulfates. The drawback of such washing is that it requires large amounts of water and gives rise to large volumes of effluent that has to be treated before it can be recycled or discarded.

In particular, in the processing of color papers and films after the fixing or bleaching-fixing bath, it is usual to place several washing baths before the stabilizing bath. A stabilizing bath can be also used to reduce residual color and increase dye stability. The stabilization bath can contain a color stabilizer such as formaldehyde or a precursor of formaldehyde, hardening agents, alkanolamines, biocids (for example derivatives of the chloromethylisothiazolone or benzoisothiazolone type), etc. Stabilization baths are described in Research Disclosure September 1996 N° 38957, section XX, D.

However, to achieve shorter the processing times for photographic materials in “minilabs” (small units for automatic rapid photographic processing), a reduction in the number of washing baths is sought. In particular, processing time can be reduced if the processed photographic material is passed from the fixing or bleaching-fixing bath directly into a stabilization bath with no intermediate washing. However, in that case, constituents of the fixing or bleaching-fixing bath are then carried over into the stabilization bath. As a result, thiosulfates, sulfates, silver complexes of the silver-dithiosulfate type, ferric complexes, etc. are introduced in the stabilization bath. When these compounds are present in the stabilization bath, they degrade it through the formation of precipitates, sulfur, etc. A photographic material processed in such a degraded stabilization bath will display unacceptable sensitometric characteristics. In addition, the total quantity of pollutants found in these seasoned stabilization baths is generally greater than 10 g/l, whereas seasoned washing solutions contain a concentration of pollutants of about 1 g/l. With such a pollutant concentration, the treatment of the solution by conventional methods, such as for example reverse osmosis or ultrafiltration, is difficult.

European Patent 655,419 describes a process for treating photographic effluents resulting from a bleaching or fixing step. This process comprises the step of adding to the effluent a polymer that forms a metal-polymer complex with the metals contained in the effluent, and the step of separating of this metal-polymer complex from the effluents using a single layer membrane filter with pore size between 0.05 and 10 micrometers. The type of membrane used discriminates solely on the basis of the molecular size of the chemical species it retains. Molecules or particles that are smaller than the pore size pass through. This method uses a polymer of high average molecular weight, between 50,000 and 500,000, and cannot be implemented with complexing polymers of molecular weight lower than 50,000. In addition, the type of membrane used does not allow the separation of multivalent ionized salts such as thiosulfate. This leaves the treated water unfit for recycling in a photographic treatment bath, because the accumulation of thiosulfate in photographic baths adversely affects the sensitometric quality of the photographic products developed in them.

French Patent 2,773,891 describes a process for the treatment of a photographic stabilization bath containing at least 2 g/l of thiosulfate by means of a nanofiltration system. However, when seasoned solutions containing more than 7 g/l of thiosulfates are to be treated, nanofiltration requires the application of an average pressure of 30 bars at ambient temperature. This limits permeate yield (expressed as a percentage of the volume of the solution to be treated). If the pressure is too low, the level of thiosulfate in the permeate will not be kept below the value that would allow to reuse the permeate in the development of photographic products without impairing the sensitometric performance of the film.

It is therefore desirable to have a nanofiltration process that uses lower pressures.

It is also desirable to have a process for removing from an aqueous photographic effluent comprising one or more photographic processing baths, silver in complexed form and (or) thiosulfates contained in this effluent, whereby the effluent can be recycled and re-used for photographic processing, even when the initial effluent was heavily polluted, i.e., when the total pollutant concentration exceeds 10 g/l.

It is also desirable to have a process for removing from a seasoned photographic bath chemical species such as silver in complexed form and (or) thiosulfates contained therein, that will allow the elimination or recovery of chemical species while at the same time replenishing in the bath with the water and the organic compounds that are necessary for maintaining the efficacy of the bath.

Given the problems arising from the use of rapid photographic processing, it is desirable to have systems that will treat and recycle effluents from photographic baths as completely as possible, i.e., that make it possible to recycle the water.

### SUMMARY OF THE INVENTION

The object of the present invention is to provide a method to remove chemical pollutants from an aqueous photographic effluent containing silver in complexed form and (or) thiosulfates whereby the quantities of chemical pollutants discharged into the sewers or present in photographic processing, and the volume of water required for photographic processing, are both reduced.

This object and others are achieved by the method of the present invention comprising the steps of:

a) adding to the aqueous photographic effluent at least one agent able to (i) combine with the silver and (or) thiosulfate and (ii) form at least one compound of molecular weight Mₓ, whereby two phases are formed, one liquid and one solid,

b) adjusting the pH at value in the range of from 3 to 6.5, and

c) allowing the effluent to pass through nanofiltration unit with a cut-off threshold below Mₓ.

The cut-off threshold corresponds to the minimum size of the particles or molecules that the nanofiltration unit holds back.

### BRIEF DESCRIPTION OF THE DRAWING

FIG. 1 is a schematic view of a processing facility for an exposed photographic material, said processing facility comprising a nanofiltration unit.

### DESCRIPTION OF THE PREFERRED EMBODIMENTS

The method of the invention affords a photographically utilizable permeate, i.e., a solution that can be re-used in one of the processing baths, either directly or in the preparation or replenishment of such a bath, while at the same time maintaining the sensitometric characteristics of the photographic products processed in such baths within the set tolerance limits of the photographic process. The method of the present invention permits a significant reduction in the volume of photographic effluents because it affords a permeate released by the nanofiltration unit that can be reused directly in a photographic processing bath. For example, the permeate can be re-used to make up for evaporation from the bleaching, fixing, bleaching-fixing or stabilization baths, or to prepare a replenishing solution for such baths from concentrated solution, or it can be sent back into a washing bath.

The agent that is added to the photographic effluent must combine with the silver, which is present in a complexed form of the silver dithiosulfate type, and (or) the thiosulfate, to yield for example a complex or an addition product through the formation e.g. of a covalent or electrostatic bond. The agents that can be used for this purpose include complexing agents such as, for example, ethylenediaminetetra-acetic acid, nitrilotriacetic acid, polyacrylic acid, polyvinylsulfonic acid and poly(iminoacetic) acid, and salts of these acids, polythioureas, quaternary polyethyleneimines and polyethyleneimines (PEIs). According to a particularly advantageous embodiment of the invention, the complexing agent is a polyethyleneimine and the quantity of polyethyleneimine added to the effluent is at least 1 g/l and preferably between 15 and 20 g/l.

According to a specific embodiment, the liquid and solid phases obtained after step a) are separated from each other before step c). Preferably, the liquid and solid phases are separated after step b), i.e. after the pH has been adjusted at a value from 3 to 6.5. The techniques that can be used to separate the liquid and solid phases from each other include for example filtration, decantation and centrifugation.

After the addition of the agent that combines with silver and (or) thiosulfate, the solution may be stirred mechanically or by other means. In a specific embodiment of the invention, after the addition of the agent that combines with the silver and (or) thiosulfate to the aqueous photographic effluent, the pH of the effluent being treated is adjusted to a value between 4.5 and 5.5.

The nanofiltration unit used in the method of the invention is a classical cell comprising one or more nanofiltration membranes able to yield a permeate fit for photographic use. Nanofiltration is a method based on phenomena of diffusion and convection through a porous membrane of pore size about 1 nm. It allows the separation of components with sizes in solution of the order of a nanometer. Monovalent ionized salts and non-ionized organic compounds with molecular weights below the cut-off threshold of the membrane cross this type of membrane. For nanofiltration, the cut-off thresholds of the membranes are between 200 and 500 daltons. In contrast, multivalent ionized salts and non-ionized organic compounds of molecular weight higher than the cut-off threshold of the membrane are strongly retained. The solution that has crossed the membrane is called the filtrate or permeate and the solution that is retained by the membrane is called the concentrate or retentate. Nanofiltration membranes can be either inorganic or organic. Organic membranes are membranes based on cellulose acetate, poly(amide/imide), polysulfone, acrylic polymers, polyacrylonitriles or fluorinated polymers. Inorganic membranes are ceramic membranes. The membranes can be mounted on supports to design nanofiltration units. There are two main types of units: tubular units and spiral units. Tubular units are made of hollow porous tubes on which is fixed the membrane. The solution circulates inside the tubes. The units can be placed either in series or in parallel. Spiral units comprise a plane membrane wound up around a hollow perforated tube designed to collect the permeate. A plastic mesh is placed between the membranes to space them and create turbulence in the fluid circulation. To exert the required pressure on the liquid being treated, the membrane rolls are inserted into tubular pressure vessels with seals at the ends. It is also possible to use disk-shaped or plate-shaped units stacked on top of each other.

According to the present invention, the nanofiltration unit is able to retain pollutants contained in a bath situated after a fixing or bleaching-fixing bath. For example, if this bath is a stabilizing bath situated immediately after the fixing or bleaching-fixing bath, with no intermediate washing bath, and if the permeate is to be used for the preparation of a fresh stabilization bath, then the nanofiltration unit preferably retains the thiosulfate and the silver that are present in complexed form, and does not retain the organic compounds initially present in the stabilization bath. According to the invention, the nanofiltration unit can be used under pressures of less than 30 bars (3×10⁶ Pa), preferably in the range of from 10 (10⁶ Pa) to 20 (2×10⁶ Pa)bars, without adversely affecting the efficacy of the process. According to one embodiment, the nanofiltration unit comprises several membranes in series. With nanofiltration membranes in series, the flow rates and yields of the unit can be improved. The nanofiltration membranes that can be used in the method of the invention are, for example, membranes NF45 FILMTEC®, NF70 FILMTEC®, NF90 FILMTEC® and NF200FILMTEC® marketed by DOW Europe Separation Systems®, membranes DK OSMONICS®, MX OSMONICS® and SV OSMONICS® marketed by OSMONICS Inc. Also membranes MPS34 SELRO® and MPS44 SELRO® sold by KOCH MEMBRANE SYSTEMS Inc.

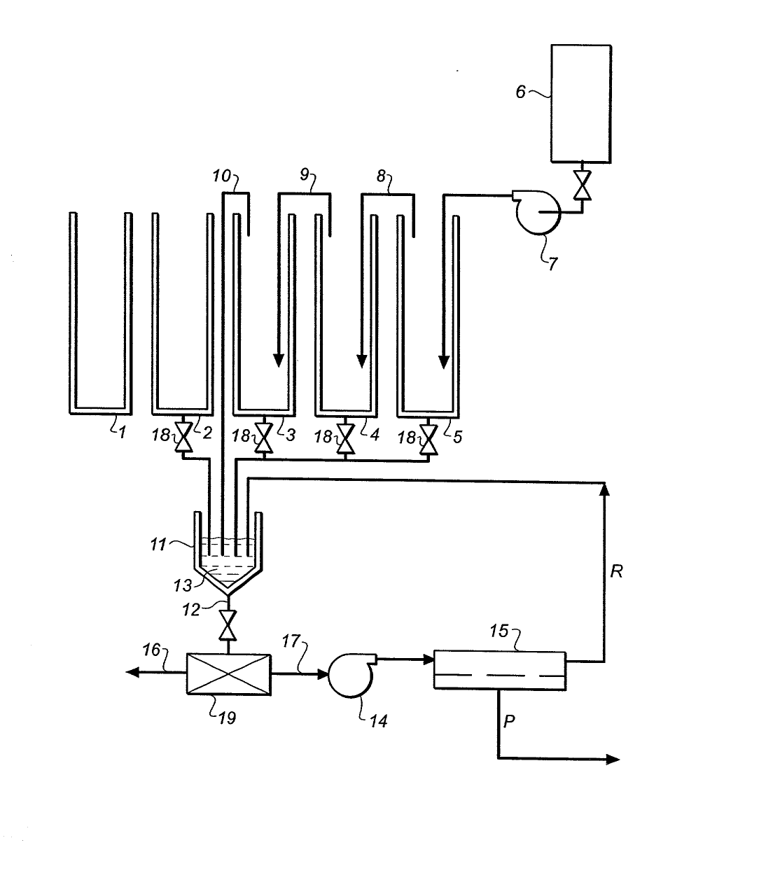

The following description refers to the drawing in which FIG. 1 depicts an embodiment of the process according to the invention.

FIG. 1 is a schematic representation of a photographic processing line that incorporates a set-up for the implementation of the method of the invention. As shown in FIG. 1, during the photographic processing a photographic material (not represented in the figure) is conveyed by a belt into the development bath 1, the bleaching-fixing bath 2, the stabilization bath 3, followed by two stabilization and (or) washing baths 4 and 5. A replenishment solution 6 for the stabilization bath is introduced by means of a pump 7 upstream into the washing bath 5. The overflow 8 from bath 5 flows through piping to bath 4. The overflow 9 from bath 4 flows through piping into stabilization bath 3. The overflow 10 from the stabilization bath then flows through piping to a collector tank 11 fitted with an outlet 12 from which wastewater is drawn for treatment. By means of drain 12 solution 13 can be recovered and treated by addition of an agent that will combine with silver and (or) thiosulfate, for example polyethyleneimine to form a compound of molecular weight Mₓ. The solid and liquid phases 16 and 17 are then separated, for example by means of filtration unit 19, and the pH of the liquid phase 17 is adjusted to a value between 3 and 6.5, preferably between 4.5 and 5.5.

The pH adjustment can also be made before the separation of the solid and liquid phases 16 and 17. The solid phase 16 can be treated using conventional techniques to recover metals (for example silver) such as electrolysis. The liquid phase 17 is sent by a pump 14 into the nanofiltration system 15 and the permeate (P) is recovered and sent back into the baths 1, 2, 3, 4, 5 and (or) 6. In a preferred embodiment of the invention, the permeate is used to prepare the replenishing solution 6 or it can be sent back exclusively into the stabilization bath 3. The retentate R from the nanofiltration system 15 is sent to the collector tank 11.

Once they are seasoned, the contents of the fixing bath 2, the stabilization bath 3 and the stabilization and (or) washing baths 4 and 5 can also be transferred by means of the valves 18 to the collector tank 11 for treatment.

In a variant of the method of the invention, the set-up comprises a single washing bath 4, and the replenishing solution 6 is run into the washing bath 4. In another variant the set-up has no washing bath, and the replenishing solution 6 is run directly into the stabilization bath 3.

This process is particularly well suited to the treatment of stabilization baths used in “minilabs” because it makes it possible to recycle water in the stabilization bath without eliminating the organic substances initially present in the stabilization bath, while at the same time recovering chemicals such as complexed silver, complexed iron, thiosulfates and sulfates. Advantageously, the process of the present invention can be used to treat stabilization baths from the processing of color photographic papers such as processes C-41 FLEXICOLOR® and FLEXICOLOR SM® marketed by EASTMAN KODAK, and stabilization baths from the processing of color photographic films such as processes EKTACOLOR RA4® and EKTACOLOR RA2-SM® marketed by EASTMAN KODAK. It can also be used in reversal color processing methods.

The method of the invention can be used to treat the mixture of stabilization baths used in the processing of photographic papers and films. Through the use of a single process for treating stabilization baths, the costs associated with effluent treatment and the complexity of implementing such treatment can be reduced.

The treatment of stabilization baths of the present invention can be readily integrated into a minilab because it requires only a simple technical installation by the operator in charge of the development of the photographic materials.

The invention is described in detail in the following examples.

### EXAMPLES

### Example 1

This example concerns the treatment of a seasoned stabilization bath from a color photographic paper process EKTACOLOR RA-2SM® marketed by EASTMAN Kodak.

The EKTACOLOR RA-2SM® process comprises the following steps:

| | |
|---|---|
| Development | 25 s at 40° C. |
| Bleaching-fixing | 25 s at 35-41° C. |
| Stabilization | 1 min 30 s at 32° C. |
| Drying | at 60° C. |

The seasoned stabilization bath (pH=6.7) contained the following chemicals at the stated concentrations:

| | |
|---|---|
| Thiosulfate: | 10.93 g/l |
| Sulfate: | 1.49 g/l |
| Fe: | 1.58 g/l (as iron-EDTA complex) |
| Ag: | 1.40 g/l (as silver-dithiosulfate complex). |

16 liters of this seasoned stabilization bath were submitted to the following procedure: To the stabilization bath to be treated was added 10 g/l of polyethyleneimine (supplied by Aldrich, catalog number 18, 197-8) as a solution containing 50% by weight. The resulting solution was stirred for 15 min. The pH was then 8.5 at 20° C. The pH was adjusted to 5 with acetic acid (Aldrich, catalog number 33, 882-6). Two phases were obtained, one of which was a slurry. The liquid and solid phases were separated from each other by means of a filter (0.45 microns). The filtrate was then passed through a nanofiltration unit fitted with an NF45 FILMTEC® membrane sold by DOW Europe Separation Systems with a rated surface area of 2.21 square meters and a cut-off threshold of 200 g/mol. The pressure applied to the nanofiltration unit was 20 bars. The concentrations of the chemical species in the permeate were measured as a function of the yield of permeate (percentage of the solution being treated). A yield of 90% of permeate meant that the permeate recovered accounted in volume for 90% of the initial untreated volume.

For comparison, the seasoned stabilization bath was treated according to the same procedure as above, except that the pretreatment of the effluent by addition of polyethyleneimine was omitted. The same nanofiltration unit fitted with an NF45 FILMTEC membrane under a pressure of 20 bars was used. The concentrations of chemical species in the permeate were measured as a function of the yield of permeate.

The results are set out in Table 1.

TABLE 1

| [Thiosulfate] | | | [Ag] in complexed form | | |
|---|---|---|---|---|---|
| (ppm) | | | (ppm) | | |
| Yield of | | | Yield of | | |
| permeate | Invention | Comparison | perme- | Invention | Comparison |
| (%) | (20 bars) | (20 bars) | ate (%) | (20 bars) | (20 bars) |
| 15 | 124 | 141 | 15 | 0.55 | 4.1 |
| 30 | 127 | 155 | 28 | 0.62 | 5.0 |
| 43 | 145 | 191 | 43 | 0.73 | 7.1 |
| 55 | 148 | 235 | 55 | 0.83 | 9.3 |
| 65 | 178 | 325 | 65 | 0.98 | 13.9 |
| 72 | 192 | 450 | 72 | 1.15 | 19.5 |
| 81 | 234 | 1190 | 81 | 1.40 | 55 |
| 90 | 289 | 2010 | 86 | 1.70 | 111 |

With the method of the invention, a low concentration of thiosulfate and complexed silver can be maintained even when the yield of permeate is greater than 80%. To eliminate thiosulfate and silver from a seasoned bath, the method according to the invention proves much more efficacious than using a nanofiltration unit without pre-treatment with the polyethyleneimine.

### Example 2

In this example, the procedure of Example 1 was repeated except that the pressure applied to the nanofiltration unit was set at 10 bars (10⁶ Pa) (instead of 20 bars as in Example 1). The comparative (with no ethyleneimine) test failed to operate correctly at this pressure, and so without ethyleneimine, it was necessary to raise the pressure applied to the nanofiltration system to 15 bars.

The results are set out in Table 2.

TABLE 2

| [Thiosulfate] | | | [Ag] in complexed form | | |
|---|---|---|---|---|---|
| (ppm) | | | (ppm) | | |
| Yield of | | | Yield of | | |
| permeate | Invention | Comparison | perme- | Invention | Comparison |
| (%) | (10 bars) | (15 bars) | ate (%) | (10 bars) | (15 bars) |
| 6 | 246 | 98 | 6 | 1.18 | 7 |
| 11 | 250 | 98 | 11 | 1.23 | 7.3 |
| 35 | 289 | 164 | 26 | 1.28 | 8.8 |
| 48 | 345 | 185 | 47 | 1.68 | 13.8 |
| 60 | 362 | 440 | 63 | 2.19 | 28.2 |
| 71 | 545 | 925 | 69 | 2.82 | 50 |
| 74 | 661 | 1574 | 74 | 3.42 | 81.4 |
| 88 | 1128 | | 88 | 6.83 | |

The maximum yield of permeate of the invention (88%) obtained with nanofiltration under 10 bars (10⁶ Pa) was thus greater than the maximum yield of permeate in the comparative test, even though the pressure in the comparative test was higher (15 bars). The method according to the invention allowed the pressure applied to the nanofiltration unit to be lowered to 10 bars, whereas using a nanofiltration system without polyethyleneimine to treat a seasoned bath, required a minimum pressure of 15 bars (comparison).

### Example 3

In this example, 15 liters of the seasoned stabilization bath of Example 1 was treated using the following procedure:

To the solution to be treated, was added 10 g/l of a 50% weight solution of polyethyleneimine (supplied by Aldrich, catalog number 18, 197-8). The resulting solution was stirred for 1 hour. The pH was then 8.5 at 20° C. The pH was adjusted to 5 with acetic acid (Aldrich, catalog number 33, 882-6). The liquid and solid phases were separated from each other by means of a filter (0.45 microns). The filtrate was then passed through a nanofiltration unit fitted with an NF45 FILMTEC® membrane sold by DOW Europe Separation Systems with a rated surface area of 2.21 square meters. The nanofiltration was conducted under two applied pressures, 10 and 20 bars. When the maximum yield of permeate was reached the concentrations of the chemical species present in the permeate, the throughput (1/h.m²) treated by the membrane of the nanofiltration system and the operating temperature of the membrane were determined.

For comparison, 15 liters of the seasoned stabilization bath of Example 1 was treated using the following procedure:

To the solution to be treated was added 10 g/l of a 50% weight solution of polyethyleneimine (supplied by Aldrich, catalog number 18, 197-8). The resulting solution was stirred for 1 hour. The pH was then 8.5 at 20° C. The filtrate was then treated directly (no filtration or adjustment of the pH to 5) using a nanofiltration unit fitted with an NF45 FILMTEC® membrane sold by DOW Europe Separation Systems with a rated surface area of 2.21 square meters and a cut-off threshold of 200 daltons. The pressure applied to the nanofiltration unit was 20 bars. When the maximum yield of permeate was reached the concentrations of the chemical species present in the permeate, the throughput (1/h per m² of membrane) treated by the membrane of the nanofiltration unit and the operating temperature of the membrane were determined.

The results are set out in Table 3.

TABLE 3

| | Comparison | Invention | Invention |
|---|---|---|---|
| | (20 bars) | (20 bars) | (10 bars) |
| Maximum yield | 78 | 89 | 88 |
| of permeate (%) | | | |
| Membrane throughput | 9.67 | 65 | 10.56 |
| (1/h. m²) | | | |
| Membrane operating | 45° | 30° | 37° |
| temperature (° C.) | | | |
| [Ag] in complexed form | 91 | 1.7 | 6.8 |
| in the permeate (ppm) | | | |
| [Fe] in complexed form | 21 | 3.3 | 12 |
| in the permeate (ppm) | | | |
| [S₂O₃] in the permeate | 3,824 | 289 | 1,128 |
| (ppm) | | | |
| [SO₄] in the permeate | 237 | 24 | 91 |
| (ppm) | | | |

The method according to the invention manifestly improved the maximum yield of permeate even when the pressure applied to the membrane of the nanofiltration unit was lowered to 10 bars. In addition, the membrane throughput was also improved. In the comparison, the operating temperature reached the upper limit recommended by the manufacturer. This was due to irreversible clogging of the membrane, i.e., the membrane could not be regenerated and so became unusable. The concentrations of the chemical species measured in the permeate clearly show the efficacy of the method according to the invention. This experiment clearly shows that if there is no pH adjustment of the solution (comparative test), then the pollutant concentrations in the permeate are higher.

### Example 4

In this example, the permeate of the invention described in Table 1 was used to prepare a fresh stabilization bath for the EKTACOLOR RA2-SM® process. To prepare this bath, 17 ml of stabilization bath concentrate was diluted with 3 liters of permeate.

A second stabilization bath was prepared by diluting the stabilization bath concentrate with water in the same conditions of dilution.

An exposed photographic paper, EKTACOLOR Royal®, was then submitted to the EKTACOLOR RA-2 SM process using the following processing sequence, the stabilization bath being as described previously:

| | |
|---|---|
| Development | 25 s at 40° C. |
| Bleaching-fixing | 25 s at 35-41° C. |
| Stabilization | 1 min. 30 s at 32° C. |
| Drying | at 60° C. |

The sensitometric results are set out in Table 5 below.

TABLE 5

| | |
|---|---|
| Fresh sensitometry (neutral exposure) | δ Dmin = 0 |
| | δ Speed = 0 |
| | δ Dmax = 0 |
| | δ contrast = 0 |
| Image stability/aging in daylight (14 days | Δ (δ Dmin) blue = +0.01 |
| storage, 50 KLUX) | Δ (δ Dmin) green = 0 |
| | Δ (δ Dmin) red = +0.01 |
| Image stability/aging in the dark (14 days at | Δ (δ Dmax) blue = +0.1 |
| 70° C.-50% relative humidity) | Δ (δ Dmax) green = 0 |
| | Δ (δ Dmax) red = 0 |

δ x is the difference between the sensitometric characteristic x observed when the paper is treated with a stabilization bath prepared with fresh water and when the photographic paper is treated with a stabilization bath prepared using the permeate.

Δ(δ x) is the difference between the values of δ x after 14 days aging in the conditions stated in the table above.

The invention has been described in detail with particular reference to certain preferred embodiments thereof, but it will be understood that variations and modifications can be effected within the spirit and scope of the invention.

What is claimed is:

1. A method for removing pollutants from an aqueous photographic effluent containing silver in complexed form and (or) thiosulfates, comprising the steps of:
a) adding to said aqueous photographic effluent at least one agent able to (i) combine with the silver and/or the thiosulfate to form at least one compound of molecular weight Mₓ, and (ii) form a liquid phase and a solid phase in the effluent;
b) adjusting the pH at a value in the range of from 3 to 6.5; and
c) allowing the effluent to pass through a nanofiltration unit with a cut-off threshold lower than Mₓ.

2. The method of claim 1, wherein the liquid and solid phases obtained in step a) are separated from each other before step c).

3. The method of claim 2, wherein said liquid and solid phases are separated from each other by filtration, decantation or centrifugation.

4. The method of claim 1, wherein the pH is adjusted at a value in the range of from 4.5 to 5.5.

5. The method of claim 1, wherein said agent able to combine with the silver and (or) thiosulfate is a complexing agent.

6. The method of claim 1, wherein said agent able to combine with the silver and (or) thiosulfate is a polyethyleneimine.

7. The method of claim 6, wherein the quantity of said polyethyleneimine added is at least 1 g/l.

8. The method of claim 6, wherein said polyethyleneimine is added in an amount in the range of from 15 to 20 g/l.

9. The method of claim 1, wherein said aqueous photographic effluent containing silver in complexed form and (or) thiosulfates, further contains wastewater carried out from a seasoned stabilization bath placed after a fixing or bleaching-fixing bath.

10. A method for the photographic processing of a photographic material containing exposed silver halides, comprising the steps of:
a) passing said photographic material through a fixing or bleaching-fixing bath, and then through at least one washing and (or) stabilizing bath, and
b) treating the effluent from at least one of said baths by the method as defined in claim 1.
